(19) United States
(12) Patent Application Publication
(10) Pub. No.: US 2020/0166039 A1
(43) Pub. Date: May 28, 2020

(54) TURBOMACHINE AND TURBOMACHINE MANUFACTURING METHOD

(71) Applicant: KABUSHIKI KAISHA TOYOTA JIDOSHOKKI, Aichi-ken (JP)

(72) Inventors: Hidefumi MORI, Kariya-shi (JP); Junya SUZUKI, Kariya-shi (JP); Kazuki OKAZAKI, Kariya-shi (JP)

(73) Assignee: KABUSHIKI KAISHA TOYOTA JIDOSHOKKI, Aichi-ken (JP)

(21) Appl. No.: 16/673,058

(22) Filed: Nov. 4, 2019

(30) Foreign Application Priority Data
Nov. 28, 2018 (JP) 2018-222928

(51) Int. Cl. F04D 17/10; F04D 25/06; F04D 29/053; F04D 29/057; H02K 7/14

(52) U.S. Cl. CPC F04D 17/10; F04D 25/0606; F04D 29/053; F04D 29/057; F05B 2260/301; F05B 2230/60; F05B 2240/53; F05B 2240/60; H02K 7/14

(57) ABSTRACT

A turbomachine includes a housing, an impeller, a shaft, and first and second radial foil bearings that rotationally support the shaft. The motor includes a stator and a rotor. The shaft includes a first inner ring and a second inner ring. The first inner ring is formed integrally with the shaft as a part of the shaft. The second inner ring is formed separately from the shaft. The first inner ring includes a first opposed end portion that is opposed to a first end portion of the rotor. The second inner ring includes a second opposed end portion that is opposed to a second end portion of the rotor. The second opposed end portion is fixed to the shaft such that the second opposed end portion and the first opposed end portion hold the rotor in between to apply preload in an axial direction to the rotor.

### BACKGROUND

### 1. Field

The present disclosure relates to a turbomachine and a turbomachine manufacturing method.

### 2. Description of Related Art

Japanese Laid-Open Patent Publication No. 2011-169190 discloses a turbomachine. The turbomachine includes a housing, an impeller, and a shaft. The housing has an impeller chamber and a motor chamber, which accommodates a motor. The impeller is accommodated in the impeller chamber. When the impeller is rotated as the motor operates, fluid is pressurized. The shaft extends in an axial direction to couple the impeller and the motor to each other.

The motor includes a stator and a rotor. The stator is fixed to the housing. The rotor includes a first end in the axial direction, a second end in the axial direction, and a tubular outer circumferential portion extending from the first end to the second end. The rotor rotates inside the stator.

The housing accommodates first and second radial foil bearings, which rotationally support the shaft. The first radial foil bearing includes a first inner ring, and the second radial foil bearing includes a second inner ring. The first inner ring, the rotor, and the second inner ring are arranged on the shaft in order from the side closer to the impeller. The first inner ring, the rotor, and the second inner ring are held integrally by a fixing member threaded to the second end of the shaft.

When the turbomachine is used as an air compressor in a fuel cell system, rotation of the rotor of the motor rotates the impeller via the shaft. Accordingly, air, which is an external fluid, is pressurized to the stack of the fuel cell system.

The above-described first inner ring, rotor, and second ring are integrated merely by threading the fixing member to the shaft. Thus, the axial force of the shaft may be insufficient for the value required in the turbomachine. For example, when the rotor rotates at a high speed, the shaft may be bent so that the impeller contacts the wall surface of the impeller chamber. In some cases, such contact causes problems such as unusual noises, and the rotation speed of the rotor is required to be limited to suppress the occurrence such problems.

### SUMMARY

Accordingly, it is an objective of the present disclosure to provide a turbomachine capable of rotating a shaft at a relatively high speed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a turbomachine is provided that includes a housing that includes an impeller chamber and a motor chamber accommodating a motor, an impeller accommodated in the impeller chamber, the impeller being configured to pressure-feed fluid by rotation of the motor, a shaft that extends in an axial direction to couple the impeller and the motor to each other, and first and second radial foil bearings that rotationally support the shaft in the housing. The motor includes a stator fixed to the housing and a rotor that rotates radially inside the stator. The rotor includes a first end portion in the axial direction, a second end portion in the axial direction, and a tubular outer circumferential portion that extends from the first end portion to the second end portion. The shaft includes a first inner ring and a second inner ring. The first inner ring constitutes a part of the first radial foil bearing and is formed integrally with the shaft as a part of the shaft. The second inner ring constitutes a part of the second radial foil bearing and is formed separately from the shaft. The first inner ring includes a first opposed end portion that is opposed to the first end portion of the rotor. The second inner ring includes a second opposed end portion that is opposed to the second end portion of the rotor. The second opposed end portion is fixed to the shaft such that the second opposed end portion and the first opposed end portion hold the rotor in between to apply preload in the axial direction to the rotor.

In another aspect, a turbomachine manufacturing method is provided. The turbomachine includes a housing that includes an impeller chamber and a motor chamber accommodating a motor, an impeller accommodated in the impeller chamber, the impeller being configured to pressure-feed fluid by rotation of the motor, a shaft that extends in an axial direction to couple the impeller and the motor to each other, and first and second radial foil bearings that rotationally support the shaft in the housing. The motor includes a stator fixed to the housing and a rotor that rotates radially inside the stator. The rotor includes a first end portion in the axial direction, a second end portion in the axial direction, and a tubular outer circumferential portion that extends from the first end portion to the second end portion. The shaft includes a first inner ring and a second inner ring. The first inner ring constitutes a part of the first radial foil bearing and is formed integrally with the shaft as a part of the shaft. The second inner ring constitutes a part of the second radial foil bearing and is formed separately from the shaft. The first inner ring includes a first opposed end portion that is opposed to the first end portion of the rotor. The second inner ring includes a second opposed end portion that is opposed to the second end portion of the rotor. The second opposed end portion is fixed to the shaft such that the second opposed end portion and the first opposed end portion hold the rotor in between to apply preload in the axial direction to the rotor. The manufacturing method includes: forming the shaft from a shaft material; attaching the rotor to an outer circumferential surface of the shaft; and fixing the second inner ring to the shaft while pressing the rotor in the axial direction with the first inner ring and the second inner ring.

In another aspect, a turbomachine manufacturing method is provided. The turbomachine includes a housing, a motor and an impeller accommodated in the housing, a shaft that extends in an axial direction to couple the impeller and the motor to each other, and first and second radial foil bearings that rotationally support the shaft in the housing. The manufacturing method includes: forming the shaft from a shaft material, wherein a first inner ring that constitutes a part of the first radial foil bearing is formed integrally with the shaft as a part of the shaft; attaching a rotor of the motor to an outer circumferential surface of the shaft; preparing a second inner ring that constitutes a part of the second radial foil bearing, the second inner ring being formed separately from the shaft; and fixing the second inner ring to the shaft while pressing the rotor attached to the shaft in the axial direction with the first inner ring and the second inner ring.

Other features and aspects will be apparent from the following detailed description, the drawings, and the claims.

### BRIEF DESCRIPTION OF THE DRAWINGS

FIG. 1 is a cross-sectional view of a turbomachine according to a first embodiment.

FIG. 2 is an exploded cross-sectional view showing the shaft of the turbomachine of FIG. 1 and components surrounding the shaft.

FIG. 3 is a cross-sectional view showing a state in which some of the components of FIG. 2 are assembled.

FIG. 4 is a cross-sectional view showing a state in which the components of FIG. 2 are assembled.

FIG. 5 is an exploded cross-sectional view showing the shaft of a turbomachine according to a second embodiment and components surrounding the shaft.

FIG. 6 is a cross-sectional view showing a state in which the components of FIG. 5 are assembled.

FIG. 7 is an exploded cross-sectional view showing the shaft of a turbomachine according to a third embodiment and components surrounding the shaft.

FIG. 8 is a cross-sectional view showing a state in which the components of FIG. 7 are assembled.

FIG. 9 is an exploded cross-sectional view showing the shaft of a turbomachine according to a fourth embodiment and components surrounding the shaft.

FIG. 10 is a cross-sectional view showing a method for manufacturing a rotary body including the shaft of FIG. 9.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

First to fourth embodiments of the present disclosure will now be described with reference to the drawings.

### First Embodiment

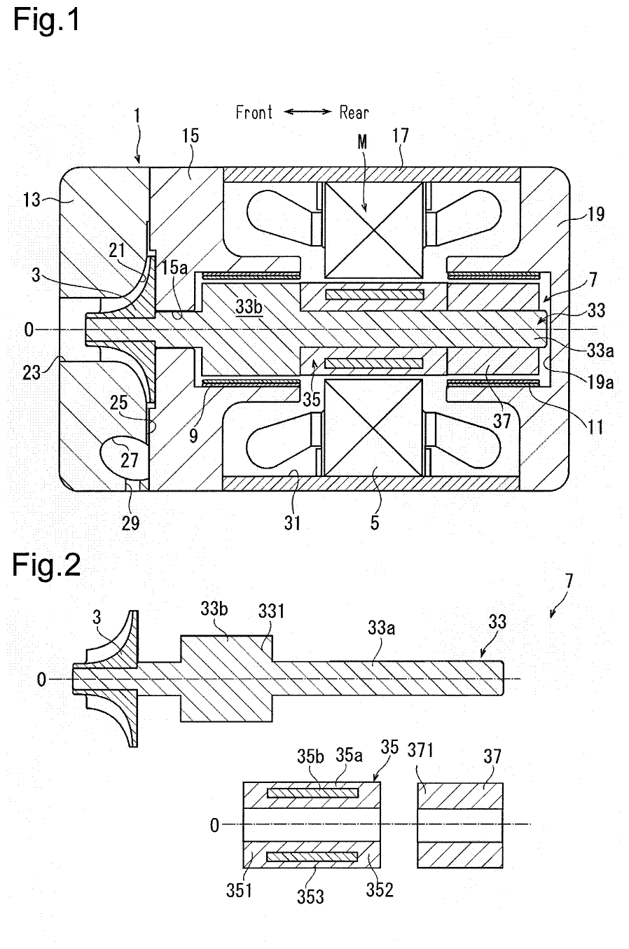

A turbomachine according to the first embodiment includes a housing 1, an impeller 3, and a shaft 33 as shown in FIG. 1. Hereinafter, the direction along the axis O of the shaft 33 will be referred to as an axial direction. For illustrative purposes, the side in the axial direction on which the impeller 3 of the turbomachine is arranged will be referred to as the front, and the opposite side will be referred to as the rear. These directions are used to represent relative arrangements or configurations in illustrated states and do not necessarily represent permanent relative positions or positions in use.

The housing 1 includes a front housing member 13, a center housing member 15, a cylinder 17, and a rear housing member 19. The front housing member 13, the center housing member 15, the cylinder 17, and the rear housing member 19 are arranged in order in the axial direction and joined together.

The front housing member 13 and the center housing member 15 cooperate to define an impeller chamber 21, a diffuser 25, and a discharge chamber 27. The front housing member 13 has a suction port 23. The suction port 23 has a first end (the right end in the drawing), which is connected to the impeller chamber 21, and a second end (the left end in the drawing), which opens to the outside. The impeller chamber 21 is connected to the outside via the suction port 23. The impeller chamber 21 is also connected to the diffuser 25. The diffuser 25 is connected to the discharge chamber 27. The front housing member 13 has a discharge port 29, which is connected to the discharge chamber 27 and opens to the outside. The discharge chamber 27 is connected to the outside via the discharge port 29.

The center housing member 15, the cylinder 17, and the rear housing member 19 cooperate to define a motor chamber 31. The center housing member 15 has a shaft hole 15a. The shaft hole 15a has a first end (the left end in FIG. 1), which is connected to the impeller chamber 21, and a second end (the right end in FIG. 1), which is connected to the motor chamber 31. The impeller chamber 21 is connected to the motor chamber 31 via the shaft hole 15a. The rear housing member 19 has a shaft hole 19a, which is located at a position away from the shaft hole 15a in the axial direction. The shaft hole 19a and the shaft hole 15a are coaxial.

The impeller 3 is rotationally accommodated in the impeller chamber 21. A motor M includes a stator 5 and a rotor 35. The stator 5 is secured to the inner circumferential surface of the cylinder 17 in the motor chamber 31. The shaft 33 is accommodated in the motor chamber 31 and arranged radially inside the stator 5. The shaft 33 extends in the axial direction and couples the impeller 3 and the motor M to each other. A rotary body 7 includes the shaft 33, the rotor 35, and a second inner ring 37.

The rotor 35 includes a rotor core 35a, which includes laminated steel plates, and permanent magnets 35b, which are held inside the rotor core 35a. The number of the permanent magnets 35b may be changed as appropriate. The rotor 35 includes a first end portion 351 (a front end) in the axial direction, a second end portion 352 (a rear end) in the axial direction, and a tubular outer circumferential portion 353 extending from the first end portion 351 to the second end portion 352. The rotor 35 rotates inside the stator 5.

A first radial foil bearing 9 is arranged in the center housing member 15. A second radial foil bearing 11 is arranged in the rear housing member 19. The first and second radial foil bearings 9, 11 rotationally support the shaft 33.

The shaft 33 is a monolithic component in which a shaft body 33a and a first inner ring 33b are formed integrally. The shaft body 33a extends in the axial direction, and the first inner ring 33b is located at a position closer to the front end of the shaft body 33a. The first inner ring 33b constitutes a part of the first radial foil bearing 9. The shaft body 33a is a column having a smaller diameter than the first inner ring 33b, and the first inner ring 33b is a column having a larger diameter than the shaft body 33a. The shaft body 33a and the first inner ring 33b are coaxial. The rear portion of the first inner ring 33b is a first opposed end portion 331, which is opposed to the first end portion 351 of the rotor 35.

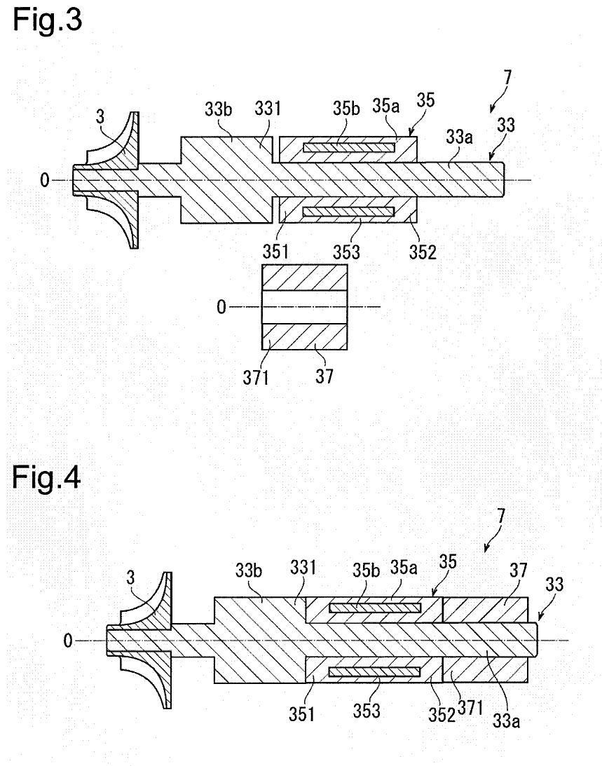

The shaft 33 is formed by cutting an iron alloy shaft material in a shaft forming process. The impeller 3 is fixed to the front end of the shaft body 33a. A cylindrical rotor 35 is attached to the outer circumferential surface of the rear portion of the shaft body 33a as shown in FIG. 3. The outer diameter of the rotor 35 is equal to the outer diameter of the first inner ring 33b.

As shown in FIG. 4, the cylindrical second inner ring 37 is fixed to a part of the shaft body 33a close to the rear end by shrink fitting. The second inner ring 37 constitutes a part of the second radial foil bearing 11. The front portion of the second inner ring 37 is a second opposed end portion 371, which is opposed to the second end portion 352 of the rotor 35.

The rotary body 7 is obtained through a fixing process. In the fixing process, the second inner ring 37 is heated to a high temperature and fitted to the shaft body 33a at a normal temperature. At this time, the second inner ring 37 is pressed toward the first inner ring 33b. Thereafter, the second inner ring 37 is cooled to a normal temperature.

The thus obtained rotary body 7 is assembled with other components including the housing 1 to obtain the turbomachine. The rotor 35 of the rotary body 7 is arranged along the outer circumferential surface of the shaft body 33a and is located between the first inner ring 33b and the second inner ring 37. More specifically, the first end portion 351 of the rotor 35 contacts the first opposed end portion 331 of the first inner ring 33b, and the second opposed end portion 371 of the second inner ring 37 contacts the second end portion 352 of the rotor 35. The first inner ring 33b and the second inner ring 37 compress the rotor 35 in the axial direction. Further, the second opposed end portion 371 and the first opposed end portion 331 hold the rotor 35 in between to apply preload in the axial direction to the rotor 35. The outer diameter of the second inner ring 37 is equal to the outer diameters of the first inner ring 33b and the rotor 35.

When the turbomachine is used as an air compressor in a fuel cell system, rotation of the rotor 35 rotates the impeller 3 in the impeller chamber 21. Accordingly, air, which is an external fluid, is drawn in through the suction port 23. When the kinetic energy of the drawn-in air is converted into pressure energy by the diffuser 25, the air is compressed. The compressed air is pressurized to the discharge chamber 27. The high-pressure air in the discharge chamber 27 is supplied to the stack of the fuel cell system.

The first inner ring 33b of the present embodiment, which is a part of the shaft 33, is formed integrally with the shaft body 33a. In contrast, the second inner ring 37 is formed separately from the shaft 33 and fixed to the shaft 33. Further, the second opposed end portion 371 of the second inner ring 37 and the first opposed end portion 331 of the first inner ring 33b hold the rotor 35 in between to apply preload in the axial direction to the rotor 35. Thus, when the shaft 33 attempts to bend due to high speed rotation of the rotor 35, such bending of the shaft 33 is limited since the first inner ring 33b and the second inner ring 37 hold the rotor 35 in between.

Specifically, if the center portion in the axial direction of the shaft 33 is bent to project radially outward, the ends of the shaft 33 project in the opposite direction, so that the first inner ring 33b and the rotor 35 are pulled away from each other, and the rotor 35 and the second inner ring 37 are pulled away from each other. However, since the first inner ring 33b and the second inner ring 37 apply preload in the axial direction to the rotor 35, the above-described tensile force is reduced. The shaft 33 thus resists bending. Particularly, since the first inner ring 33b is formed as a part of the shaft 33, the first inner ring 33b and the second inner ring 37 firmly hold the rotor 35 in between. This limits bending of the shaft 33.

As described above, the shaft 33 of the turbomachine has a great axial force. Thus, when the rotor 35 rotates at a high speed, problems such as unusual noises caused by the impeller 3 contacting the wall surface of the impeller chamber 21 are unlikely to occur. In other words, the permissible rotation speed of the shaft 33 is increased.

Therefore, the shaft 33 of this turbomachine can be rotated at a relatively high speed.

Since the second inner ring 37 of this turbomachine is fixed to the shaft body 33a by shrink fitting, an axial force can be produced by a simple manufacturing method.

The second inner ring 37 may simply be press-fitted to the shaft body 33a. In this case also, an axial force can be produced by a simple manufacturing method.

### Second Embodiment

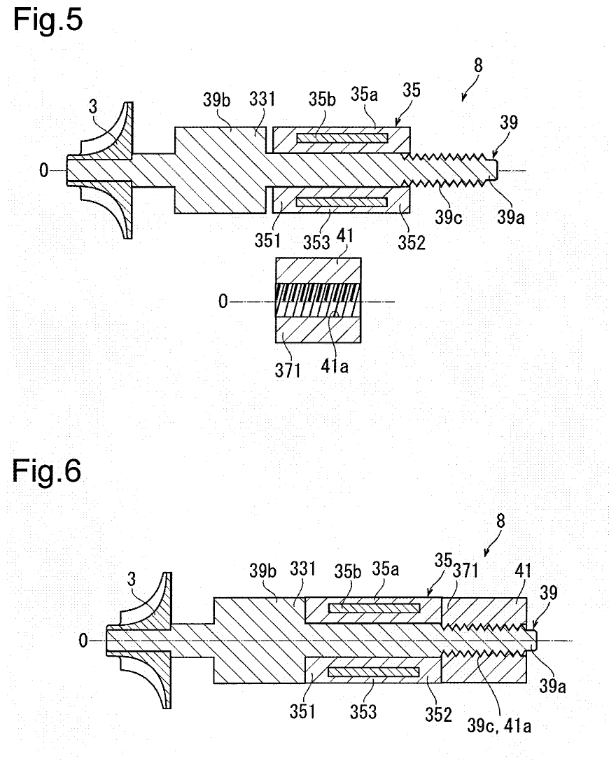

A turbomachine of the second embodiment employs a rotary body 8 shown in FIGS. 5 and 6.

The rotary body 8 includes a shaft 39, the rotor 35, and a second inner ring 41 as shown in FIG. 5. The shaft 39 is a monolithic component in which a shaft body 39a and a first inner ring 39b are formed integrally. The shaft body 39a extends along an axis O, and the first inner ring 39b is located in a front portion of the shaft body 39a. The shaft body 39a has an external thread 39c at the rear portion. The second inner ring 41 has an internal thread 41a on the inner circumferential surface.

The rotary body 8 is obtained through a fixing process. In the fixing process, the second inner ring 41 is fixed to the shaft body 39a by screwing the internal thread 41a to the external thread 39c as shown in FIG. 6. The other configurations of the turbomachine and the rotary body 8 are the same as those of the first embodiment.

The turbomachine of the second embodiment has the same operational advantages as those of the first embodiment. In the rotary body 8 of the second embodiment, the axial force of the shaft 39 can be easily controlled by controlling the tightening torque of the internal thread 41a applied to the external thread 39c.

### Third Embodiment

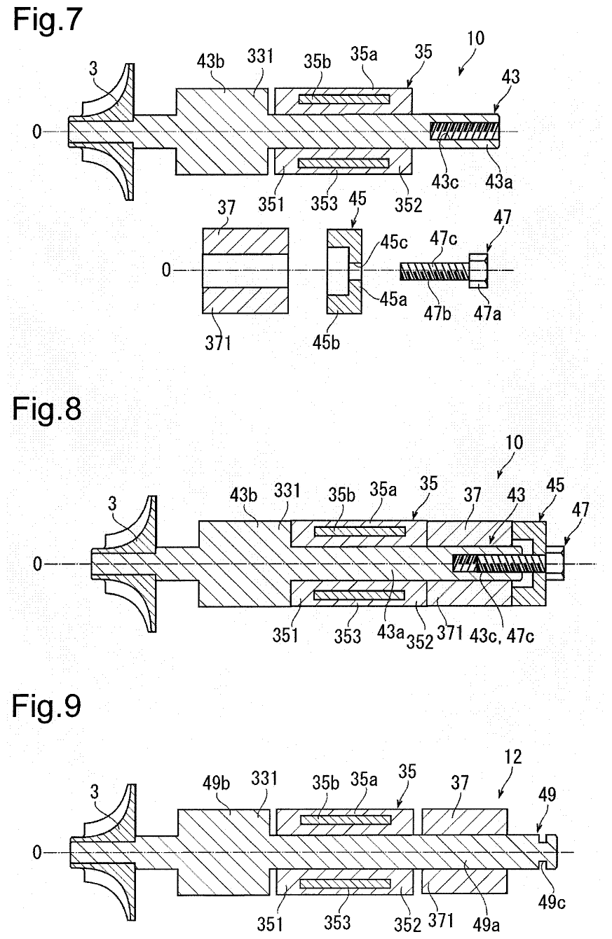

A turbomachine of the third embodiment employs a rotary body 10 shown in FIGS. 7 and 8.

The rotary body 10 includes, as shown in FIG. 7, a shaft 43, the rotor 35, the second inner ring 37, a pressing member 45, and a bolt 47, which is a screw member. The shaft 43 is a monolithic component in which a shaft body 43a and a first inner ring 43b are formed integrally. The shaft body 43a extends along an axis O, and the first inner ring 43b is located in a front portion of the shaft body 43a. The fixing process for obtaining the rotary body 10 includes first to fourth steps. In the first step, the shaft 43, the rotor 35, and the second inner ring 37 are prepared. A shaft body 43a of the shaft 43 has a pressure applying internal thread 43c at the rear portion. The rotor 35 and the second inner ring 37 have the same configurations as those of the first embodiment.

In the first step, the pressing member 45 and the bolt 47 are prepared. The pressing member 45 includes a base 45a, which is a disk, and a tubular pressing portion 45b, which protrudes in the axial direction from the base 45a. The base 45a has an insertion hole 45c, which extends through the base 45a in the axial direction. The bolt 47 includes a head 47a and a shank 47b. The shank 47b has the pressure applying external thread 47c, which is screwed into the pressure applying internal thread 43c. The diameter of the insertion hole 45c is larger than the diameter of the shank 47b of the bolt 47 so that the shank 47b can be inserted into the insertion hole 45c.

In the second step, the rotor 35 is attached to the outer circumferential surface of the shaft body 43a. In the third step, which is subsequent to the first and second steps, the second inner ring 37 is heated to a temperature higher than that of the shaft 43. In the fourth step, which is subsequent to the third step, the shank 47b of the bolt 47 is inserted into the insertion hole 45c of the pressing member 45 as shown in FIG. 8, and the pressure applying external thread 47c of the shank 47b is threaded into the pressure applying internal thread 43c. In this step, the pressure applying external thread 47c presses the pressing member 45 to move the second inner ring 37 and the rotor 35 in the axial direction toward the first inner ring 43b. In this state, the second inner ring 37 is cooled to a normal temperature. The second inner ring 37 is thus shrink-fitted to the shaft body 43a. The other configurations of the turbomachine and the rotary body 10 are the same as those of the first embodiment.

The turbomachine of the third embodiment also has the same operational advantages as those of the first embodiment. The use of the rotary body 10 of the third embodiment allows the axial force of the shaft 43 to be easily controlled by controlling the temperature difference between the shaft body 43a and the second inner ring 37 and the tightening torque between the pressure applying internal thread 43c and the pressure applying external thread 47c.

The pressing member 45 and the bolt 47 may be removed from the rotary body 10, so that the turbomachine includes a rotary body with the shaft 43, the rotor 35, and the second inner ring 37.

### Fourth Embodiment

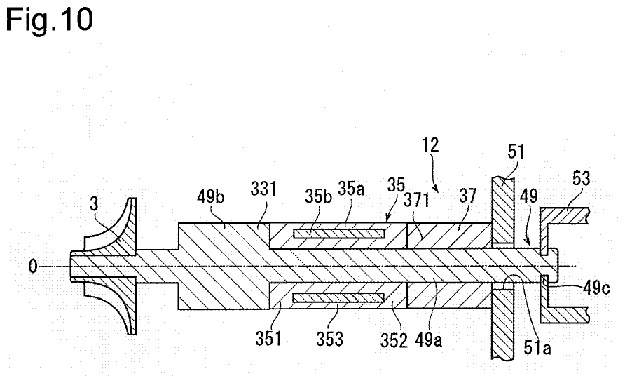

A turbomachine of the fourth embodiment employs a rotary body 12 shown in FIGS. 9 and 10.

The rotary body 12 includes a shaft 49, the rotor 35, and the second inner ring 37 as shown in FIG. 9. The shaft 49 is a monolithic component in which a shaft body 49a and a first inner ring 49b are formed integrally. The shaft body 49a extends along an axis O, and the first inner ring 49b is located in a front portion of the shaft body 49a. The fixing process for obtaining the rotary body 12 includes first to fourth steps. In the first step, the shaft 49, the rotor 35, and the second inner ring 37 are prepared. The shaft body 49a of the shaft 49 has an engagement groove 49c, which is an engagement portion. The rotor 35 and the second inner ring 37 have the same configurations as those of the first embodiment.

In the first step, a jig 51 and a chuck 53 shown in FIG. 10 are prepared. The jig 51 has an insertion hole 51a, which extends through the jig 51 in the axial direction. The insertion hole 51a has a diameter that allows the shaft body 49a to be inserted. The chuck 53 is configured to be engaged with the engagement groove 49c so as to pull the shaft 49 rightward as viewed in the drawing.

In the second step, the rotor 35 is attached to the outer circumferential surface of the shaft body 49a. In the third step, which is subsequent to the first and second steps, the second inner ring 37 is heated to a temperature higher than that of the shaft 49. In the fourth step, which is subsequent to third step, the shaft body 49a is inserted into the insertion hole 51a of the jig 51. The chuck 53 is the engaged with the engagement groove 49c to pull the shaft 49 rightward as viewed in the drawing. In this manner, the shaft body 49a is moved in the axial direction by using the engagement groove 49c while pressing, with the jig 51, the second inner ring 37 and the rotor 35 such that the second inner ring 37 keeps contacting the rotor 35 and the rotor 35 keeps contacting the first inner ring 49b. In this state, the second inner ring 37 is cooled to a normal temperature. After the cooling, the jig 51 and the chuck 53 are removed to obtain the rotary body 12. The second inner ring 37 is thus shrink-fitted to the shaft body 49a. The other configurations of the turbomachine and the rotary body 12 are the same as those of the first embodiment.

The turbomachine of the fourth embodiment also has the same operational advantages as those of the first embodiment. The use of the rotary body 12 of the fourth embodiment allows the axial force of the shaft 49 to be easily controlled by controlling the temperature difference between the shaft body 49a and the second inner ring 37 and the tensile force of the chuck 53.

All the characteristic features disclosed in the first to fourth embodiments may be changed without departing from the scope of the disclosure.

The turbomachine of the present disclosure can be employed, for example, in an air compressor, particularly in an air compressor used in a fuel cell system.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A turbomachine comprising:
a housing that includes an impeller chamber and a motor chamber accommodating a motor;
an impeller accommodated in the impeller chamber, the impeller being configured to pressure-feed fluid by rotation of the motor;
a shaft that extends in an axial direction to couple the impeller and the motor to each other; and
first and second radial foil bearings that rotationally support the shaft in the housing, wherein
the motor includes
a stator fixed to the housing, and
a rotor that rotates radially inside the stator,
the rotor includes
a first end portion in the axial direction,
a second end portion in the axial direction, and
a tubular outer circumferential portion that extends from the first end portion to the second end portion,
the shaft includes
a first inner ring that constitutes a part of the first radial foil bearing, the first inner ring being formed integrally with the shaft as a part of the shaft, and
a second inner ring that constitutes a part of the second radial foil bearing, the second inner ring being formed separately from the shaft,
the first inner ring includes a first opposed end portion that is opposed to the first end portion of the rotor,
the second inner ring includes a second opposed end portion that is opposed to the second end portion of the rotor, and
the second opposed end portion is fixed to the shaft such that the second opposed end portion and the first opposed end portion hold the rotor in between to apply preload in the axial direction to the rotor.

2. The turbomachine according to claim 1, wherein the second inner ring is press-fitted to the shaft.

3. The turbomachine according to claim 1, wherein the second inner ring is shrink-fitted to the shaft.

4. The turbomachine according to claim 1, wherein
the shaft includes an external thread on an outer circumferential surface,
the second inner ring includes an internal thread on an inner circumferential surface, and
the external thread of the shaft is threaded to the internal thread of the second inner ring.

5. A turbomachine manufacturing method, wherein
the turbomachine includes
a housing that includes an impeller chamber and a motor chamber accommodating a motor,
an impeller accommodated in the impeller chamber, the impeller being configured to pressure-feed fluid by rotation of the motor,
a shaft that extends in an axial direction to couple the impeller and the motor to each other, and
first and second radial foil bearings that rotationally support the shaft in the housing,
the motor includes
a stator fixed to the housing, and
a rotor that rotates radially inside the stator,
the rotor includes
a first end portion in the axial direction,
a second end portion in the axial direction, and
a tubular outer circumferential portion that extends from the first end portion to the second end portion,
the shaft includes
a first inner ring that constitutes a part of the first radial foil bearing, the first inner ring being formed integrally with the shaft as a part of the shaft, and
a second inner ring that constitutes a part of the second radial foil bearing, the second inner ring being formed separately from the shaft,
the first inner ring includes a first opposed end portion that is opposed to the first end portion of the rotor,
the second inner ring includes a second opposed end portion that is opposed to the second end portion of the rotor,
the second opposed end portion is fixed to the shaft such that the second opposed end portion and the first opposed end portion hold the rotor in between to apply preload in the axial direction to the rotor, and
the manufacturing method comprises:
forming the shaft from a shaft material;
attaching the rotor to an outer circumferential surface of the shaft; and
fixing the second inner ring to the shaft while pressing the rotor in the axial direction with the first inner ring and the second inner ring.

6. The turbomachine manufacturing method according to claim 5, wherein the fixing the second inner ring to the shaft includes fitting, to the shaft, the second inner ring of a temperature higher than that of the shaft.

7. The turbomachine manufacturing method according to claim 5, wherein the fixing the second inner ring to the shaft includes
forming a pressure applying internal thread on the shaft,
attaching the rotor to the outer circumferential surface of the shaft,
heating the second inner ring to a temperature higher than that of the shaft, and
threading a pressure applying external thread of a screw member into the pressure applying internal thread, thereby causing a pressing member pressed by the screw member to move the second inner ring, the temperature of which is higher than that of the shaft, and the rotor toward the first inner ring in the axial direction.

8. The turbomachine manufacturing method according to claim 5, wherein the fixing the second inner ring to the shaft includes
forming an engagement portion in the shaft,
attaching the rotor to the outer circumferential surface of the shaft,
heating the second inner ring to a temperature higher than that of the shaft, and
moving the shaft in the axial direction by using the engagement portion while pressing, with a jig, the second inner ring, the temperature of which is higher than that of the shaft, and the rotor such that the second inner ring keeps contacting the rotor and the rotor keeps contacting the first inner ring.

9. A turbomachine manufacturing method, wherein
the turbomachine includes
a housing,
a motor and an impeller accommodated in the housing,
a shaft that extends in an axial direction to couple the impeller and the motor to each other, and
first and second radial foil bearings that rotationally support the shaft in the housing,
the manufacturing method comprises:
forming the shaft from a shaft material, wherein a first inner ring that constitutes a part of the first radial foil bearing is formed integrally with the shaft as a part of the shaft;
attaching a rotor of the motor to an outer circumferential surface of the shaft;
preparing a second inner ring that constitutes a part of the second radial foil bearing, the second inner ring being formed separately from the shaft; and
fixing the second inner ring to the shaft while pressing the rotor attached to the shaft in the axial direction with the first inner ring and the second inner ring.
